(19) United States
(12) Patent Application Publication
(10) Pub. No.: US 2007/0055584 A1
(43) Pub. Date: Mar. 8, 2007

(54) Systems and methods for tracking goods

(76) Inventors: Hans Chelniak, Hockenheim (DE); Pascale Van Laethem, Ketsch (DE); Stefan Brunner, Oftersheim (DE); Andreas Moschel, Wald-Michelbach (DE); Jochen Thierer, Bruchsal (DE); Wieland Schreiner, Mutterstadt (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/198,324

(22) Filed: Aug. 8, 2005

(51) Int. Cl. G06Q 10/00

(52) U.S. Cl. 705/28

(57) ABSTRACT

Systems and methods are provided for tracking goods. In one implementation, commercial goods are tracked in a trade zone having customs procedures. The goods include sets of bonded goods that are stored at a plurality of physically non-contiguous bonded storage locations and at least one set of unbonded goods that are stored at one or more unbonded storage locations. A virtual zone is defined to include the bonded storage locations, the sets of goods in the virtual zone forming a net inventory. A transaction request is received to execute a transaction upon a target set of goods of the commercial goods. The transaction is evaluated to determine whether the transaction affects the net inventory of the virtual zone. If the transaction affects the net inventory of the virtual zone, a message is generated for a customs authority to comply with the customs procedures.

### TECHNICAL FIELD

The present invention relates generally to the fields of logistics and transportation, including the shipping and handling of goods. More particularly, the invention relates to systems and methods for tracking goods, such as commercial goods in a trade zone, in order to ensure compliance with customs procedures.

### BACKGROUND INFORMATION

Customs authorities of trade zones have historically used paper-based customs processes to manage and record transactions with importers and exporters of commercial goods. More recently, however, many national customs authorities have progressed to electronic organization of their customs processes. For example, in the European Union (EU), an electronic customs system known as the New Computerized Transit System (NCTS) has been defined for the transit procedure. In Germany, several customs processes, such as bonded warehouse procedures, are defined according to an ATLAS (Automatisiertes Tarif- und Lokales Zoll-Abwicklungs-System) standard. Further, in the United States, customs authorities are working with systems such as the Automated Commercial System (ACS). Based on electronic systems such as these, transactions between goods dealers and the customs authorities can be handled electronically.

A goods dealer typically stores imported goods in bonded warehouses and free warehouses to manage the goods in relation to the customs authorities. FIG. 1 is a schematic diagram that illustrates an exemplary warehouse environment with a plurality of bonded warehouses 100a-100g and a plurality of free warehouses 110a-110h. In FIG. 1, the warehouses 100a-100g and 110a-110h are shown as being distributed among three plants 120a-120c at three physical locations. The goods stored in the free warehouses 110a-120h, referred to as unbonded goods, can be freely handled and moved from the free warehouses 110a-110h because import duties on these goods have already been paid by the goods dealer. However, the goods in the bonded warehouses 100a-100g, referred to as bonded goods, are still subject to oversight by a relevant customs authority, such as being liable for import duties if they are moved from the bonded warehouse 100a-100g.

A goods dealer may separately process movements from warehouses that do not involve the customs authority, referred to as “logistics processes,” and movements that do involve the customs authority, referred to as “customs processes.” In FIG. 1, an exemplary movement that only triggers logistics processes is represented by arrow 130. Exemplary movements that trigger customs processes are represented by arrows 140a-140h. As goods are moved, a human operator may decide, for example, whether the movement of these goods is a logistics process that is not relevant to compliance with the customs authority or a customs process that is relevant to compliance with the customs authority.

The logistics processes and customs processes are often handled by different computer-implemented or software systems and by different groups of people for the goods dealer. The customs processes required for an inbound or outbound movement of goods in relation to one of the bonded warehouses, such as an issuance of bonded goods from the bonded warehouse, typically interfere with corresponding logistics processes that are required for that inbound or outbound movement of goods. This interference between the customs processes and the logistics processes tends to increase in relation to the number of bonded goods that are stored, resulting in inefficiencies.

Additionally, when an item of a particular type is requested to be issued, a human operator typically decides whether a bonded or unbonded item of the requested type should be issued. For example, the bonded items can be used for re-export, whereas the unbonded items can be used for domestic sale to minimize the cost of import duties. Such frequent human intervention also results in inefficiency in the maintenance of the bonded and unbonded goods.

Thus, it is desirable to more efficiently track transactions of stored goods, while ensuring compliance with customs procedures of a local customs authority. It is further desirable to more efficiently issue bonded and unbonded goods upon request.

### SUMMARY

Consistent with embodiments of the invention, systems and methods are provided for tracking goods, such as commercial goods in a trade zone. Embodiments of the invention may ensure compliance with customs procedures, while overcoming one or more the aforementioned drawbacks in conventional solutions. Embodiments of the invention include computer-implemented systems and methods, as well as computer readable media including instructions that perform methods consistent with the invention when implemented by a computer or processor.

In accordance with one embodiment, a method is provided of tracking commercial goods in a trade zone having customs procedures. The goods comprise sets of bonded goods that are stored at a plurality of non-contiguous bonded storage locations and at least one set of unbonded goods that are stored at one or more unbonded storage locations. The method comprises defining a virtual zone that encompasses the bonded storage locations, the sets of goods in the virtual zone forming a net inventory. A transaction request is received to execute a transaction upon a target set of goods of the commercial goods. The transaction is evaluated to determine whether the transaction affects the net inventory of the virtual zone. A message is generated for a customs authority to comply with the customs procedures, if the transaction affects the net inventory of the virtual zone.

In accordance with another embodiment, a system is provided for tracking commercial goods in a trade zone having customs procedures. The goods comprise sets of bonded goods that are stored at a plurality of non-contiguous bonded storage locations and at least one set of unbonded goods that are stored at one or more unbonded storage locations. The system comprises a logistics tracker to receive a transaction request to execute a transaction upon a target set of goods of the commercial goods. The logistics tracker also evaluates the transaction to determine whether the transaction affects the net inventory of sets of goods in a virtual zone, the virtual zone encompassing the bonded storage locations. Further, a customs tracker is provided to generate a message for a customs authority to comply with the customs procedures if the transaction affects the net inventory of the virtual zone.

In accordance with yet another embodiment, a computer program product is provided for tracking commercial goods in a trade zone having customs procedures. The goods comprise sets of bonded goods that are stored at a plurality of non-contiguous bonded storage locations and at least one set of unbonded goods that are stored at one or more unbonded storage locations. The computer program product comprises a computer-usable storage medium having computer-readable program code stored therein. The computer-readable program code comprises a logistics instruction set executable to receive a transaction request to execute a transaction upon a target set of goods of the commercial goods. The logistics instruction set is also executable to evaluate the transaction to determine whether the transaction affects the net inventory of sets of goods in a virtual zone, the virtual zone encompassing the bonded storage locations. The computer-readable program further comprises a customs instruction set executable to generate a message for a customs authority to comply with the customs procedures if the transaction affects the net inventory of the virtual zone.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments consistent with the present invention may be directed to various combinations and sub-combinations of the features described in the following detailed description.

### BRIEF DESCRIPTION OF THE DRAWINGS

The accompanying drawings, which are incorporated in and constitute a part of this specification, illustrate embodiments of the invention and, together with the description, serve to explain advantages and principles of the invention.

In the drawings,

FIG. 1 is a schematic diagram of an exemplary environment comprising a plurality of bonded warehouses and free warehouses; FIG. 2 is a schematic diagram of an exemplary embodiment, consistent with the present invention, that comprises a virtual zone and a plurality of free storage locations;

FIG. 3a is a schematic diagram of an exemplary embodiment, consistent with the present invention, of the data structure of an identifier of a set of goods;

FIG. 3b is a schematic diagram of an exemplary embodiment, consistent with the present invention, of the data structure of auxiliary data associated with a set of goods;

FIG. 4 is a schematic diagram of an exemplary embodiment, consistent with the present invention, of integrated tracking software to communicate with a customs system of a customs authority; and

FIG. 5 is a flowchart of an exemplary embodiment, consistent with the present invention, of a method of tracking a set of goods in a trade zone having customs procedures.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

When goods are imported into one trade zone (referred to herein as an “importing trade zone”), such as a country or a region such as the EU, from another trade zone, import duties may be due in accordance with the importing trade zone's required customs procedures. Thus, the imported goods are often held by a receiver under a tentative “bonded” status, meaning that the import duties have not been paid on the goods. The bonded status may have one of various different values, depending on the local customs procedures. While the imported goods are in the bonded status, the imported goods typically cannot be sold domestically in the importing trade zone. Rather, the status of the imported goods must first be changed from “bonded” to “unbonded.” This change of the goods' status being referred to herein as “nationalization.” The goods in the unbonded status can be freely circulated in the trade zone because the import duties on these goods have been paid.

While in the bonded status, the imported goods are stored inside one or more bonded warehouses. However, unbonded goods may also be stored in the bonded warehouses. All transactions executed upon the bonded goods, such as movements of the goods, are generally documented. For example, financial records may be kept, such as in accordance with Generally Accepted Accounting Principles (GAAP). When a transaction is executed upon the bonded goods, the financial records are updated to reflect the transaction.

Bonded warehouses enable a goods dealer to store the goods for unlimited periods of time and at regular intervals at predetermined, registered storage locations in the importing trade zone. Each bonded warehouse can be used to store goods from outside the importing trade zone before nationalization. For the duration of their stay in a bonded warehouse, these goods are generally exempt from import duties. Bonded warehouses can also be used to store goods that are in transit to another trade zone, or goods for which import duties should only be imposed at the time that the goods are actually removed from storage, such as for domestic sale. In addition, bonded warehouses can be used to store goods that are subject to exceptional procedures that exempt the goods from import duties.

To illustrate a few examples of bonded warehouses, Germany has at least three different types of bonded warehouses, these three types being referred to as C-type, D-type, and E-type. C-type bonded warehouses are adapted to goods that are intended for re-export immediately upon leaving that bonded warehouse. A customs declaration required for the set of goods to enter the bonded warehouse generally does not require as much information as the customs declarations required to enter a D-type and E-type bonded warehouse. However, if it is later decided to naturalize the set of goods in a C-type bonded warehouse, additional information will be required at that later stage for the set of goods to become unbonded. In contrast, D-type bonded warehouses are adapted to goods that are intended for naturalization upon leaving the bonded warehouse, such as for domestic sale in the importing trade zone or another form of “free circulation” inside the importing trade zone. A customs declaration required for the set of goods to enter a D-type bonded warehouse generally requires a larger set of information than the C-type customs declaration, such as the additional information that is required to naturalize a set of goods from the C-type bonded warehouse. Further, E-type bonded warehouses are adapted to goods whose final destination is uncertain. E-type bonded warehouses are not restricted to a particular location. For example, an E-type bonded warehouse could comprise a plurality of plants at different locations.

FIG. 2 is a schematic diagram illustrating an exemplary embodiment, consistent with the present invention, that comprises a plurality of non-contiguous bonded storage locations 210a-210g and at least one unbonded storage location. For example, there may be a plurality of unbonded storage locations 230a-230h, as shown in FIG. 2. The non-contiguity of the bonded storage locations refers to the definition of a boundary around each of the individual bonded storage locations, the boundary delineating the physical extent of that bonded storage location, wherein the extent of that bonded storage location has been approved with the local customs authority. Goods passing from one of the bonded storage locations to any of the other bonded storage locations physically cross the boundaries of both of the bonded storage locations. The bonded storage locations store the bonded goods, whereas the unbonded storage locations store at least some of the unbonded goods. The bonded and unbonded storage locations 210a-210g and 230a-230h are shown as micro storage locations that are constituted by “bonded” and “free” warehouses, respectively, in FIG. 2. These bonded and unbonded storage locations 210a-210g and 230a-230h are distributed among a plurality of macro storage locations, shown as plants 220a-220c in FIG. 2.

When a goods dealer receives a set of goods from a sender, at least one identifier comprising information about the set of goods, referred to as an economic customs procedure identification (ECPID), is created and associated with the set of goods. The ECPID may be stored in a memory of a computer, for example. The ECPID may comprise, for instance, information derived from a “goods receipt” associated with the receipt of the set of goods. The goods receipt may be at least partially based on shipping information that the sender transmitted to the goods dealer before the set of goods was received. Alternatively, the goods receipt may be created upon receipt, such as when a truck containing the set of goods arrives at a receiving gate.

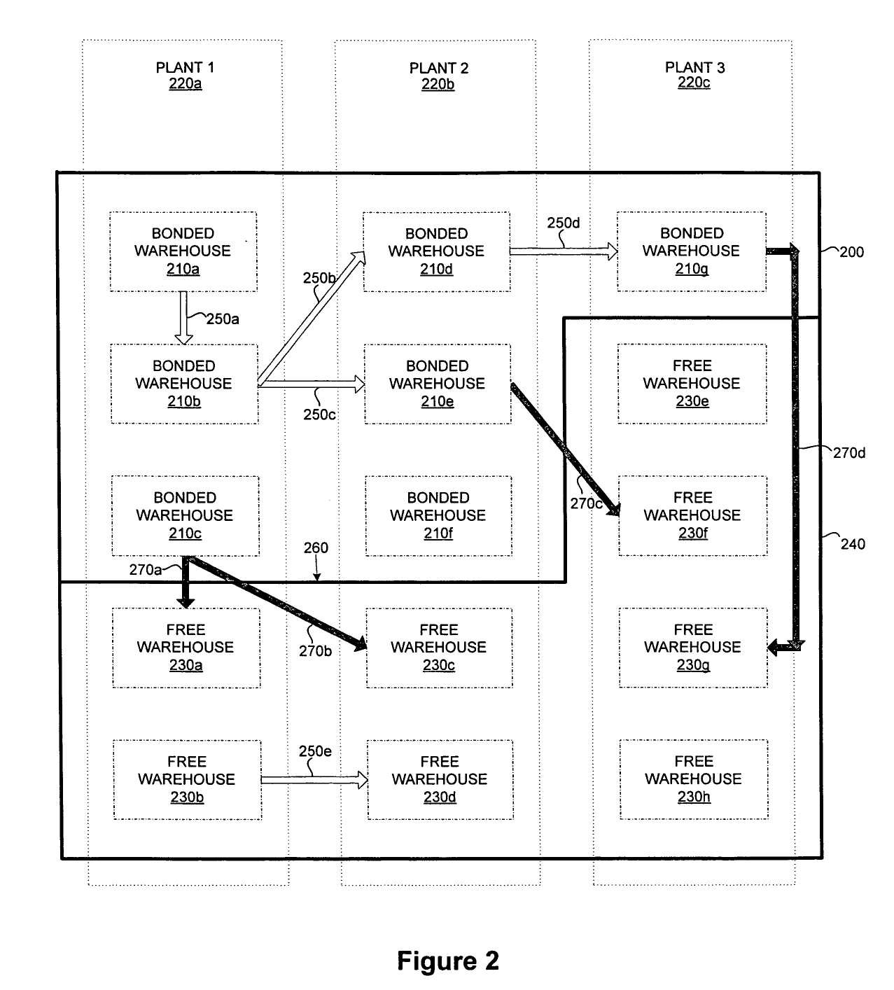

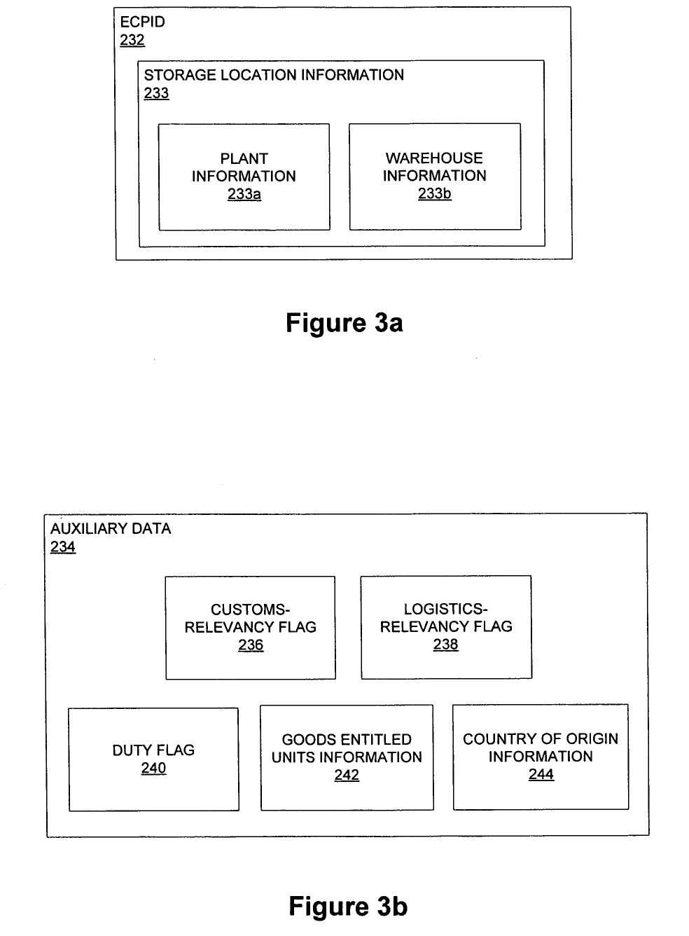

FIG. 3a is a schematic diagram of an exemplary embodiment, consistent with the present invention, of a data structure of an ECPID 232. As illustrated in FIG. 3a, the ECPID 232 comprises information 233 about a physical storage location of the set of goods, such as a plant or warehouse where the set of goods are to be physically stored. In one embodiment, the set of goods may be stored in a micro storage location that is enclosed by a macro storage location. For example, the micro storage location may be a warehouse, identified by information, within a macro storage location that is a company plant or campus, identified by information. When the set of goods is stored in a micro location that is within a macro location, such as a warehouse within a plant, the ECPID 232 contains information identifying both the macro storage location, shown as 233a, and the micro storage location, shown as 233b. Thus, unique ECPIDs 232 are associated with sets of goods stored at different locations.

In one embodiment, auxiliary data 234 are also associated with the set of goods. FIG. 3b is a schematic diagram of an exemplary embodiment, consistent with the present invention, of a data structure of the auxiliary data 234. The auxiliary data 234 may comprise a customs-relevancy flag 236 that indicates whether that particular set of goods is relevant to compliance with the customs procedures. The auxiliary data 234 may also comprise a logistics-relevancy flag 238 that indicates whether the set of goods is relevant to logistical inventory tracking of the goods. In addition, the auxiliary data 234 may comprise a duty flag 240 that indicates the fiscal state of the set of goods, namely whether the set of goods is bonded or unbonded. Furthermore, the auxiliary data 234 may comprise information 242 about a number of unbonded goods within the goods in a particular warehouse, referred to as a number of “goods entitled units.”

The auxiliary data 234 may also identify the sets of goods by information 244 describing a country of origin (CoO), which is typically the country where the major value of the items in the set of goods was generated. For example, this can be used for embargoes, boycotts, or a determination of preferential status of the set of goods. The country of origin can determine liability for duty, import tax, and excise tax, as well as the percentages of these duties and taxes.

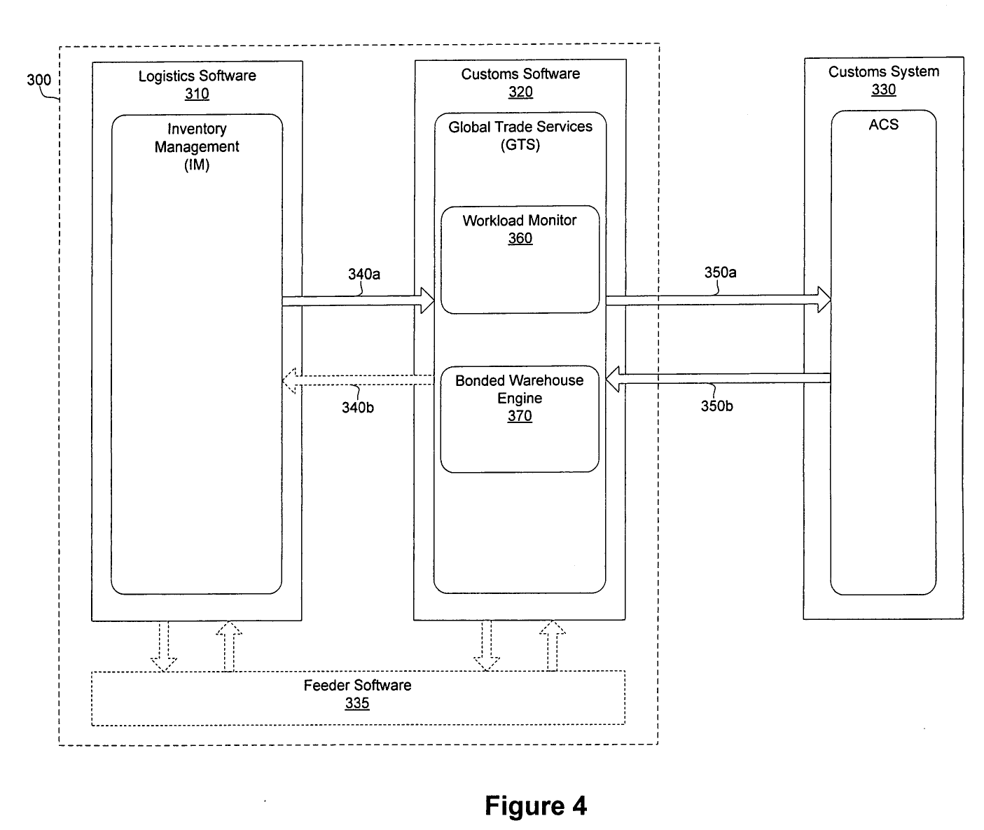

The information relevant for compliance with the customs procedures may comprise, for example, one or more of the following data: material number, quantity, weight, fiscal status (i.e., whether the goods are bonded or unbonded), fiscal origin, country of origin (CoO), actual costs, goods receipt date, reference document (e.g., PO/ASN), and item number. For example, customs software 320 may be provided (see FIG. 4) that receives all of these items of information. The fiscal status of the goods as bonded or unbonded can be manually changed when the goods are received.

In one embodiment, feeder software 335 may optionally be provided to distinguish between unbonded inventory and bonded inventory, such as by reading the duty flags of the sets of goods. Thus, customs software 320 can be limited to tracking only the bonded inventory. However, if feeder software 335 is not implemented, customs software 320 may be used to track both unbonded and bonded inventories.

Consistent with embodiments of the invention, a virtual zone 200, as shown in FIG. 2, is defined to encompass the plurality of non-contiguous bonded storage locations 210a-210g. The totality of commercial goods in the virtual zone 200 are referred to as the “net inventory” of the virtual zone 200. The unbonded storage locations 230a-230h may occupy a free zone 246. The storage location of each of the sets of goods, as recorded in the ECPID of the set of goods, is associated with being either inside or outside of the virtual zone 200.

In one embodiment, bonded goods and unbonded goods of substantially the same commercial type are combined as a mixed set of goods in the bonded storage locations 210a-210g. After receipt, documents and/or electronic records that uniquely identify the fiscal status of the goods are disassociated from the individual goods within that single set of goods. Also, no physical separation between bonded inventory and unbonded inventory is required in the warehouse. For example, a quantity of the bonded goods and a quantity of the unbonded goods can both be stored in a single warehouse or a single storage bin. Since there is no printed label or other physical identifier that distinguishes the bonded quantity from the unbonded quantity, the bonded inventories may not be physically identifiable in a particular warehouse. Either bonded or unbonded items can individually be removed from that shared storage location, such as to satisfy a transaction request made by the goods dealer.

Consistent with embodiments of the invention, an integrated tracker system may be used to efficiently manage the goods stored in the bonded storage locations 210a-210g and the unbonded storage locations 230a-230h using the virtual zone 200 to track the inventory of bonded and unbonded goods while complying with the customs procedures. For example, the system may store a definition of the physical extent of the virtual zone 200. After an imported set of goods has been assigned its ECPID, transactions can be executed upon that set of goods. For example, the set of goods can be moved from its present storage location to another storage location, or otherwise removed from its present storage location.

In accordance with one embodiment, the integrated tracker system may comprise a logistics tracker that processes transaction requests. For example, when a request is made to execute a particular transaction upon the set of goods, the logistics tracker may process the transaction request to track the net inventory of bonded and unbonded goods resulting from the transaction. In addition, the system may include a customs tracker that is adapted to evaluate the transaction request to determine whether the transaction affects the net inventory of goods in the virtual zone 200. If the transaction does affect the net inventory of goods in the virtual zone 200, the customs tracker generates one or more messages for the customs authority to comply with customs procedures that require action by the goods dealer in view of the transaction.

In one embodiment, the integrated tracker system may be implemented with one or more computers or processors. For example, integrated tracking software may comprise computer-readable program code stored on a computer-usable storage medium for execution by a computer or processor. The integrated tracking software may also be packaged into one or more modules or components and/or provided in the form a computer program product. A computer, including a server, workstation, laptop, or other processor, may execute the computer-readable program code to perform the functions of the integrated tracker system, as detailed herein.

For purposes of illustration, FIG. 4 is a schematic diagram of an exemplary embodiment, consistent with the present invention, of integrated tracking software 300. The integrated tracking software 300 of FIG. 4 is provided only to illustrate an exemplary embodiment of the invention and, thus, should not be used to limit the scope of the invention or its equivalents. The logistics tracker and the customs tracker are implemented as software adapted to be executed by the computers or processors (such as, for example, logistics software 310 and customs software 320, respectively, as shown in FIG. 4). Computer-readable media and computer-readable program code may be specially designed and constructed for the purposes of providing the integrated tracking software 300. Examples of computer-readable program code include, for example, machine code, such as produced by a compiler, and files containing a high level code that can be executed by the computer using an interpreter.

The integrated tracking software 300 may manage the goods stored in the virtual zone 200 and the unbonded storage locations 230a-230h, such as those shown in FIG. 2. The integrated tracking software 300 may comprise logistics software 310 to manage the net inventory of goods, customs-relevant and customs-irrelevant, held by the goods dealer, and customs software 320 to seamlessly interface with the customs system 330 of the customs authority. Consistent with an embodiment of the invention, the logistics software 310 and the customs software 320 comprise computer-readable instruction sets that form the integrated tracking software 300. The integrated tracking software 300 may optionally also comprise feeder software 335 to manage the logistics software 310 and the customs software 320.

In one embodiment, the logistics software 310 transmits data 340a to the customs software 320, such as data including ECPID's of sets of goods. The data 340a may comprise, for example, one or more of an ECPID, material number, quantity of goods, pricing information, dates, and reference document numbers, such as the reference number of a purchase order. In some circumstances, the customs software 320 also transmits data 340b to the logistics software 310. Further, the customs software 320 transmits messages to the customs system 330 of the customs authority via a stream of data 350a. Such messages may be transmitted to comply with customs procedures of the customs authority. For example, the messages in the stream of data 350a may comprise customs documents such as customs declarations. In reply, the customs system 330 may transmit messages back to the customs software 320 via another stream of data 350b. In the example of FIG. 4, the customs system 330 is shown as ACS, which is presently used by the United States customs authority. The ACS is but one example, for the sake of illustration, and other customs systems may be used depending on the customs zone, such as NCTS in the EU.

The logistics software 310 evaluates the requested transactions to keep track of the net inventory of bonded and unbonded goods. In one embodiment, the logistics software 310 comprises Inventory Management (IM) software, as shown in FIG. 4, such as IM software based on an R/3® software platform. The IM software may keep track of substantially all movements of goods, including one or more of inbound movements, outbound movements, and adjustments. The software packages described above are commercially available from SAP AG, Walldorf, Germany (“R/3” is a registered trademark of SAP AG).

The logistics software 310 may differentiate the sets of goods in the inventory by respective countries of origin, such as by reading the country of origin information contained in the auxiliary data 234 associated with the sets of goods. For outbound movements from the virtual zone 200, the country of origin may be read from the auxiliary data 234 associated with the sets of goods being moved. If the country of origin of a set of goods were not tracked, the payment of an incorrect duty could result when the set of goods is removed from the virtual zone 200.

The logistics software 310 evaluates the transactions to determine whether the transaction affects the net inventory of the virtual zone 200. For example, if a transaction comprises a movement of a target set of goods from a first storage location to a second storage location, the feeder software 335 evaluates the movement and reads the ECPID of the target set of goods to determine whether the first storage location is inside of the virtual zone 200 and the second storage location is outside of the virtual zone 200. The logistics software 310 may also track transactions that affect a characteristic of the net inventory of goods in the virtual zone 200. Other exemplary transactions that affect the net inventory of the virtual zone 200 can include (i) an issuing of the target set of goods, (ii) a scrapping request for the target set of goods or (iii) an adjustment of an inventory of the goods in one of the bonded or unbonded storage locations 210a-210g and 230a-230h.

Furthermore, the logistics software 310 may read the auxiliary data 234 associated with a target set of goods that is subject to a transaction request to determine whether the target set of goods is a customs-relevant set of goods or a customs-irrelevant set of goods based on the storage location of the target set of goods. For transactions that are relevant to compliance with the customs procedures, the logistics software 310 may trigger the customs software 320 to generate any necessary messages for the customs authority. However, for transactions that are irrelevant to compliance with the customs procedures, such as movements of certain unbonded goods from inside the virtual zone 200 to outside the virtual zone 200, interference between the logistics processes and the customs processes can be reduced by not triggering the customs software 320. Thus, the efficiency of tracking the totality of the commercial goods in the virtual zone 200 and the free zone 246 is improved.

The customs software 320, such as upon being triggered by the logistics software 310, evaluates the requested transactions to comply with the customs procedures. For example, the customs software 320 can generate any messages that need to be sent to the customs authority. The customs software 320 may also maintain customs identification information associated with the goods, such as by updating the customs identification information after a relevant movement or other transaction. In one embodiment, the customs software 320 maintains the customs identification information via an interface that can be called externally. Alternatively, portions of the maintenance may be performed manually by a human operator of the customs software 320.

In one embodiment, the customs software 320 comprises Global Trade Services (GTS) software, as shown in FIG. 4. For example, the GTS software may comprise a Workload Monitor 360 and a Bonded Warehouse Engine 370. The Workload Monitor 360 is adapted to monitor the movements of the customs-relevant goods. Based on a movement of customs-relevant goods, the Workload Monitor 360 may trigger a message to the customs authority automatically (such as if all necessary information for the customs authority is already stored) or manually (such as if further data from a human operator are required). The Bonded Warehouse Engine 370 is adapted to keep a record of the inventory of the customs-relevant goods, both bonded and unbonded.

Movements of the goods between different bonded storage locations 210a-210g within the virtual zone 200 may be logistical transactions that are not relevant to the local customs procedures in certain circumstances. For example, movements between different storage locations that are within an E-type bonded warehouse (as described above) may not need to be reported to the customs authority. In other words, these internal movements within the virtual zone 200 do not need to be evaluated further to comply with the customs procedures. Examples of such logistical transactions are shown as movements 250a-250d in FIG. 2. However, movements between different storage locations within a D-type bonded warehouse (also described above) or an FTZ-type bonded warehouse (as used in the United States) may nevertheless require a message to be sent to the customs authority. Movements of the goods between different free storage locations 230a-230h within the free zone 246 are logistical transactions that are also typically not relevant to the customs procedures. An example of such a logistical transaction is shown as movement 250e. These customs-irrelevant movements, entirely internal to either the free zone 246 or the virtual zone 200, generally would not effect a change in the net inventory of the virtual zone 200. On the other hand, a transaction request that comprises a movement request from a first storage location to a second storage location is typically relevant to the customs procedures if the first storage location is inside of the virtual zone 200 and the second storage location is outside of the virtual zone 200. These movements cross a border 260 of the virtual zone 200. Examples of such customs-relevant movements are the movements 270a-270d shown in FIG. 2. Also, internal bonded warehouse processes, such as “adjustments,” may be customs-relevant transactions because they may effect a change in the net inventory of the virtual zone 200.

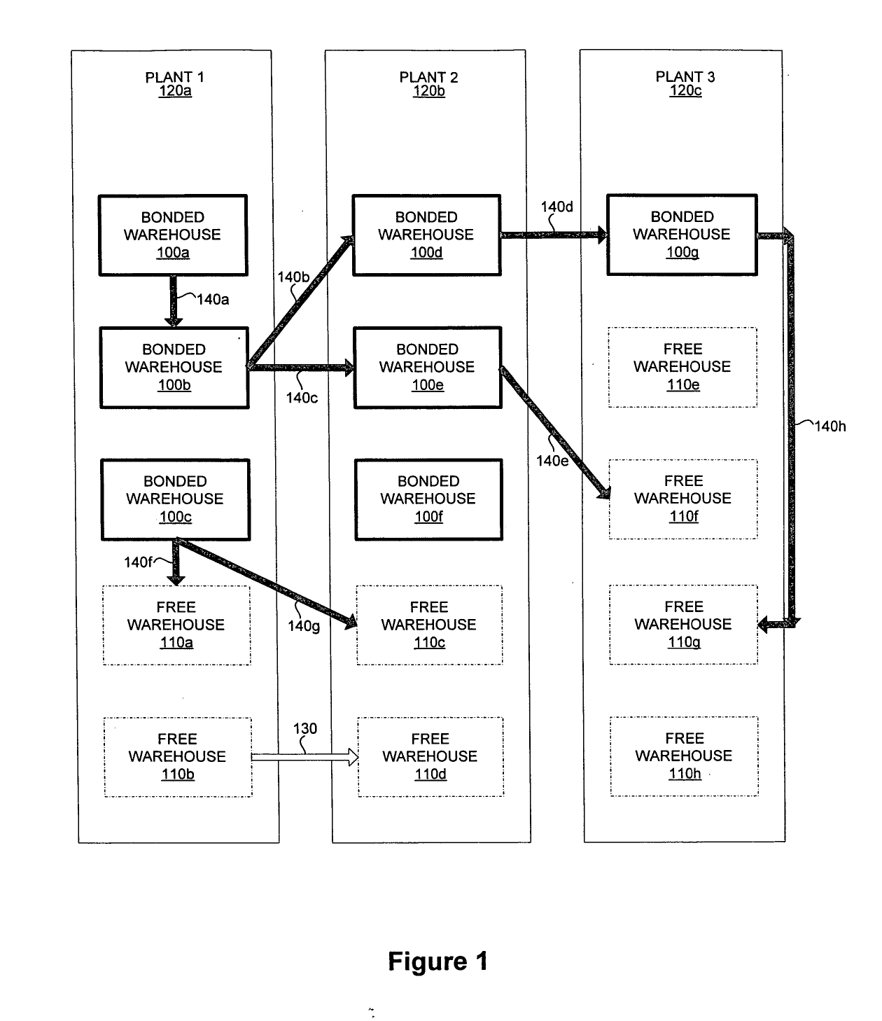

By distinguishing the customs-relevant transactions from the customs-irrelevant transactions by using the virtual zone 200, the logistics software 310 reduces the number of transactions that must be evaluated to comply with the customs procedures and allocates the compliance procedures to the customs software 320. The integrated tracking software 300 can thus improve the efficiency of tracking the inventory and complying with the customs procedures in terms of both computational resources and human resources. For example, a comparison of FIGS. 1 and 2 shows that movements 250a-250d of FIG. 2, which may be considered analogous to movements 140a-140d of FIG. 1 for the purpose of this illustration, are tracked more efficiently than movements 140a-140d for at least the reason that movements 140a-140d are internal to the virtual zone 200.

The inventory of customs-relevant sets of goods, whether bonded or unbonded, may be entirely monitored by the customs software 320. With this separation between monitoring of the customs-irrelevant goods and the customs-relevant goods, the goods issue and the goods receipt process in the logistics software 310 are substantially uninfluenced by the customs procedures that may be enforced by the customs authority for the handling of the customs-relevant goods. Because only the customs software 320 is responsible for compliance with the required customs procedures, all identifying information that is relevant to satisfying the requirements of the customs procedures is maintained by the customs software 320.

This customs-relevant identifying information may include (i) identification of the type of goods, such as a material number and/or batch number, (ii) data necessary for the customs procedures, such as a goods issue date or goods receipt date, a country of origin (CoO), a type of inventory, a quantity of inventory, and a unit of measure, and (iii) additional data, such as identification of a reference document, an owner of inventory, or the logistics software 310.

When a request is made for a transaction to be executed upon a target set of goods, the feeder software 335 evaluates the transaction and the target set of goods to determine whether the transaction and the set of goods are both customs-relevant. If the transaction and the set of goods are customs-relevant, the customs software 320 further evaluates the transaction and the set of goods, and generates any appropriate messages for the customs authority. For example, the customs software 320 can use the storage location information that is contained in the ECPID of the target set of goods to determine what customs procedures are relevant to that movement. Based on these predetermined customs procedures, the customs software 320 can either look up or create a compliant message for the customs authority. For all movements of bonded goods into or out of the virtual zone 200 defined by the ECPID's of the sets of goods, one or more messages to the customs authority may need to be generated. For example, if bonded goods are removed from the virtual zone 200, such as in an “issue goods” process, the customs software 320 generates the necessary customs declaration, reserves the necessary bonded goods, and calculates the customs value of the set of goods so that the “issue goods” process within the logistics software 310 is not affected. The “customs value” of goods is typically calculated by summing the actual costs of the goods, freight costs, and insurance costs. The customs value may be calculated based on a first-in-first-out (FIFO) rule.

The customs software 320 seamlessly manages the messages to the customs authority based on the transactions executed upon the sets of goods, substantially without interfering in the operation of the logistics software 310. For example, the messages to the customs authority may be automatically generated, and optionally also transmitted, by the customs software 320 without any intervention by a human operator to individually create the messages. For example, when a set of goods is to be moved from a first warehouse to a second warehouse, the customs software 320 automatically generates the messages for the customs authority that are mandated by the customs authority for the same category of movement of the same category of goods. Thus, the customs procedures can be complied with, without significantly impeding the performance of the logistics software 310.

The communications to the customs system 330 of the customs authority may include periodic communications and event-triggered communications. For example, the following messages are examples of communications that may be sent to the ATLAS customs system used by the German customs authority in the trade zone of Germany to declare a set of goods to one of the bonded warehouses 210a-210g. “SCW REC” is an event-triggered communication that refers to “starting customs warehouse procedure recording.” “SCW REC” informs ATLAS that a bonded warehouse process will start at an indicated location. “SCW PED” is a periodic declaration to ATLAS that a customs warehouse procedure has started. “ECWPED” is a periodic declaration indicating “standing customs warehouse procedure.” “CUS REC” is a “customs recording” message. “CUS REL” is a “customs release” message. “CUS TAX” is a tax declaration to the customs authority, and may be the final message sent to ATLAS for a particular set of goods. Corresponding messages may be transmitted to the ACS customs system used by the United States customs authority when a set of goods is introduced into a free trade zone of the U.S.

Multiple examples of transactions that can be executed upon a target set of goods in an exemplary embodiment of the integrated tracking software 300, as shown in FIG. 4, are described below. One exemplary transaction is an inbound movement of a set of unbonded goods into the virtual zone 200. For example, the inbound movement may be due to a return of goods. The reasons for a return may include, for example, claims, quality of the goods, a higher or lower quantity of the goods than expected, an incorrect purchase prders, incorrect delivery, or overstock. Because all duty-paid goods are managed in GTS as well, all goods receipt are communicated to GTS via R/3®. A customs inventory record is created in GTS for both the duty-unpaid goods and the duty-paid goods.

Another exemplary transaction is an inbound movement of a set of bonded goods into the virtual zone 200 for a return of the goods. The logistics software 310 may determine whether the storage location of the set of goods is associated with an ECPID, whether the transaction affects the net inventory of the virtual zone 200, and whether the set of goods is flagged as customs-relevant or customs-irrelevant in the auxiliary data 234. If these three prerequisites are satisfied, the GTS software is triggered and an entry is made in the workload monitor 360 of the GTS software. The net inventory of the virtual zone 200 is incremented by the receipt quantity in the GTS software. A customs value of the set of goods can be determined from a credit memo associated with the return of the set of goods, and an appropriate customs declaration can be generated by the GTS software.

Another examplary transaction is an outbound movement of a target set of goods from the virtual zone 200 within the importing trade zone, such as a domestic sale of the set of goods. This can be referred to as a “goods issue” transaction. For a domestic sale, unbonded goods may be given priority for removal from the virtual zone 200. If bonded goods are removed from the virtual zone 200, they are naturalized to become unbonded goods and an inventory record of the unbonded goods is decremented. Furthermore, the goods dealer may not need to physically distinguish bonded inventory from non-bonded inventory within a single storage location 230a-230h. In an outbound process, the integrated tracking software 300 decides whether to send bonded goods or non-bonded goods, such as depending on whether the outbound process is a re-export or a domestic sale, respectively.

Yet another example is an outbound movement of a target set of goods outside of the importing trade zone, such as for re-export to another trade zone. For re-exports, bonded goods may be given priority for removal from the virtual zone 200. When the movement request is finally entered in, for example, the R/3® software platform, the GTS software decrements the inventory of bonded goods. If it is necessary to naturalize bonded goods into unbonded goods, the GTS software can provide a transaction to permit the manual generation of a customs declaration document.

Still another example of a transaction upon a set of goods is a scrapping of the set of goods. The scrapping process may be triggered by a scrapping request made in the R/3® software platform. The scrapping request is sent to the EWM software and the GTS software. Scrapping may prefer the inventory of bonded goods to the inventory of unbonded goods. Based on the scrapping request, the GTS software generates a customs document for the customs authority. For example, the customs document for a bonded set of goods that is to be scrapped may include information such as product number, quantity, country of origin, a Harmonized Tariff System (HTS) code used as an international standard to classify products, and the customs value of the set of goods. If insufficient bonded inventory is available, unbonded inventory may be scrapped. Generally, a customs document does not need to be generated to scrap the unbonded inventory.

Another exemplary transaction is an adjustment of inventory. The adjustment request is triggered by the EWM software, and communicated through the R/3® software platform to the GTS software. The workload monitor 360 in the the GTS software changes the net inventory of goods stored in the virtual zone 200. For example, positive adjustments may increase the bonded inventory and negative adjustments may decrease the unbonded inventory. The GTS software may also summarize the net inventory of the virtual zone 200 to generate a periodic declaration document to be sent to the customs authority.

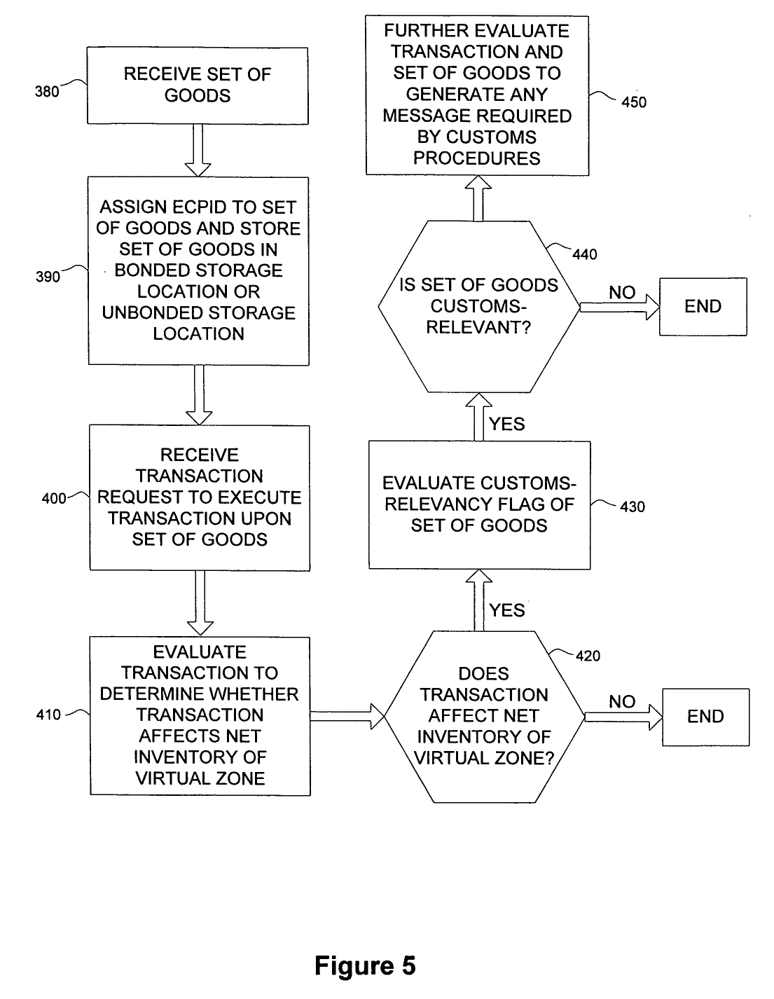

FIG. 5 is a flowchart of an exemplary embodiment of a method of tracking a set of goods for compliance with the customs procedures of the local customs authority, consistent with the present invention. In FIG. 5, the rectangular boxes represent processes of the method, whereas the hexagonal boxes represent conditional branches of the method.

After the set of goods is received, as shown by step 380 of FIG. 5, an ECPID is assigned to the set of goods, as shown by step 390. At a later time, a request is received for a transaction to be exected upon the set of goods, as shown by step 400. The transaction is evaluated to determine whether the transaction affects the net inventory of the virtual zone 200, as shown by step 410. If the requested transaction does affect the net inventory of the virtual zone 200, as shown by conditional branch 420, the customs-relevancy flag of the set of goods is evaluated, as shown by step 430. If the requested transaction does not affect the net inventory of the virtual zone 200, the evaluation of whether the transaction requires a message for the customs procedures is ended, as shown in FIG. 5. For example, for the integrated tracking software 300, ending this evaluation process may comprise performing logistical inventory tracking. If the customs-relevancy flag of the set of goods is set to the customs-relevant state, as shown by conditional branch 440, the transaction and the set of goods are further evaluated to determine whether any message is required by the customs procedures, and if so, to generate that message, as shown by step 450. However, if the customs-relevancy flag of the set of goods is set to the customs-irrelevant state, the evaluation of whether the transaction of the set of goods requires a message for the customs authority is ended, as shown in FIG. 5.

Thus, the methods, systems, and computer program products described herein decrease the influence of the customs regulations on the logistics of tracking an inventory of distributed bonded and unbonded goods. The entire inventory of bonded and unbonded goods is tracked while ensuring compliance with the relevant customs procedures. Returning the FIGS. 2 and 4, as sets of goods are moved from one of the storage locations 210a-210g, 230a-230h to another of the storage locations 210a-210g, 230a-230h, the integrated tracking software 300 ensures seamless and reliable compliance with the requirements of the customs procedures.

The foregoing description of possible implementations consistent with the present invention does not represent a comprehensive list of all such implementations or all variations of the implementations described. The description of only some implementations should not be construed as an intent to exclude other implementations. One of ordinary skill in the art will understand how to implement the invention in the appended claims in other ways, using equivalents and alternatives that do not depart from the scope of the following claims.

The methods, systems, and computer program products disclosed herein may be embodied in various forms including, for example, a data processor, such as a computer that also includes a database. Moreover, the above-noted features and other aspects and principles of the present invention may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus to perform the required methods and techniques.

What is claimed is:

1. A method of tracking commercial goods in a trade zone having customs procedures, the commercial goods comprising sets of bonded goods that are stored at a plurality of non-contiguous bonded storage locations, and the commercial goods comprising at least one set of unbonded goods that are stored at one or more unbonded storage locations, the method comprising:
defining a virtual zone to encompass the bonded storage locations, the commercial goods in the virtual zone forming a net inventory;
receiving a transaction request to execute a transaction upon a target set of goods of the commercial goods;
evaluating the transaction to determine whether the transaction affects the net inventory of the virtual zone; and
generating a message for a customs authority to comply with the customs procedures, if the transaction affects the net inventory of the virtual zone.

2. A method according to claim 1, wherein evaluating comprises evaluating a transaction that comprises a movement from a first storage location to a second storage location to determine whether the first storage location is inside of the virtual zone and the second storage location is outside of the virtual zone.

3. A method according to claim 1, wherein the commercial goods comprise customs-relevancy flags capable of individually being set to a customs-relevant state or a customs-irrelevant state, and wherein the method further comprises:
evaluating the customs-relevancy flag of the target set of goods; and
generating a message for the customs authority if the customs-relevancy flags of the target set of goods is set to the customs-relevant state.

4. A method according to claim 1, wherein the commercial goods are individually associated with at least one identifier comprising information about the storage location of each set of goods, and further wherein evaluating the transaction request comprises reading the identifier associated with the target set of goods.

5. A method according to claim 4, wherein the commercial goods in the virtual zone are individually associated with a first identifier having one or more first types of information or a second identifier having one or more second types of information, and further wherein evaluating the transaction request comprises determining whether the target set of goods has one of the first identifiers or one of the second identifiers.

6. A method according to claim 1, wherein evaluating the transaction request comprises determining whether a transaction request comprises (i) an issuing of the target set of goods, (ii) a scrapping of the target set of goods, or (iii) an adjustment of an inventory of the goods in one of the bonded or unbonded storage locations.

7. An integrated tracker system for tracking commercial goods in a trade zone having customs procedures, the commercial goods comprising sets of bonded goods that are stored at a plurality of non-contiguous bonded storage locations, and the commercial goods comprising at least one set of unbonded goods that are stored at one or more unbonded storage locations, the system comprising:
a logistics tracker to:
(i) receive a transaction request to execute a transaction upon a target set of goods of the commercial goods, and
(ii) evaluate the transaction to determine whether the transaction affects the net inventory of the commercial goods in a virtual zone, the virtual zone being defined to encompass the bonded storage locations; and
a customs tracker to generate a message for a customs authority to comply with the customs procedures, if the transaction affects the net inventory of the virtual zone.

8. A system according to claim 7, wherein the logistics tracker is adapted to evaluate a transaction that comprises a movement from a first storage location to a second storage location to determine whether the first storage location is inside of the virtual zone and the second storage location is outside of the virtual zone.

9. A system according to claim 7, wherein the logistics tracker is adapted to read a customs-relevancy flag of the target set of goods, the customs-relevancy flag being capable of individually being set to a customs-relevant state or a customs-irrelevant state, to determine whether the customs-relevancy flag is set to a customs-relevant state, and further wherein the logistics tracker is adapted to generate a message for the customs authority if the customs-relevancy flag of the target set of goods is set to the customs-relevant state.

10. A system according to claim 7, wherein the logistics tracker is adapted to read an identifier associated with the target set of goods, the identifier comprising information about the storage location of the target set of goods.

11. A system according to claim 10, wherein the logistics tracker is adapted to determine whether the target set of goods has an identifier associated with a first category of storage location or an identifier associated with a second type of storage location.

12. A system according to claim 7, wherein the logistics tracker is adapted to evaluate a transaction request that comprises (i) an issuing of the target set of goods, (ii) a scrapping of the target set of goods, or (iii) an adjustment of an inventory of the goods in one of the bonded or unbonded storage locations.

13. A computer program product for tracking commercial goods in a trade zone having customs procedures, the commercial goods comprising sets of bonded goods that are stored at a plurality of non-contiguous bonded storage locations, the commercial goods comprising at least one set of unbonded goods that are stored at one or more unbonded storage locations, the computer program product comprising a computer-usable storage medium having computer-readable program code stored therein, and the computer-readable program code being executable by a processor and comprising:
a logistics instruction set executable to
(i) receive a transaction request to execute a transaction upon a target set of goods of the commercial goods, and
(ii) evaluate the transaction to determine whether the transaction affects the net inventory of commercial goods in a virtual zone, the virtual zone being defined to encompass the bonded storage locations; and
a customs instruction set executable to generate a message for a customs authority to comply with the customs procedures, if the transaction affects the net inventory of the virtual zone.

14. A computer program product according to claim 13, wherein the logistics instruction set is adapted to evaluate a transaction that comprises a movement from a first storage location to a second storage location to determine whether the first storage location is inside of the virtual zone and the second storage location is outside of the virtual zone.

15. A computer program product according to claim 13, wherein the commercial goods comprise customs-relevancy flags capable of individually being set to a customs-relevant state or a customs-irrelevant state, and further wherein the customs instruction set is adapted to evaluate the customs-relevancy flag of the target set of goods.

16. A computer program product according to claim 15, wherein the logistics instruction set is adapted to generate a message for the customs authority if the customs-relevancy flag of the target set of goods is set to the customs-relevant state.

17. A computer program product according to claim 13, wherein the commercial goods are individually associated with at least one identifier comprising information about the storage location of that the commercial goods, and further wherein the customs instruction set is adapted to read the identifier associated with the target set of goods.

18. A computer program product according to claim 17, wherein the commercial goods in the virtual zone individually have an identifier associated with a first category of storage location or an identifier associated with a second category of storage location, and further wherein the customs instruction set is adapted to determine which category of identifier the target set of goods has.

19. A computer program product according to claim 13, wherein the logistics instruction set is adapted to evaluate a transaction that comprises (i) an issuing of the target set of goods, (ii) a scrapping of the target set of goods, or (iii) an adjustment of an inventory of the goods in one of the bonded or unbonded storage locations.
